(19) United States
(12) Patent Application Publication
(10) Pub. No.: US 2024/0269893 A1
(43) Pub. Date: Aug. 15, 2024

(54) BRICK LOADING/UNLOADING APPARATUS AND METHOD

(71) Applicant: HANWHA CORPORATION, Seoul (KR)

(72) Inventors: Jong Won LEE, Seoul (KR); Hyun Seok JUNG, Seoul (KR); Seung Jin KIM, Seoul (KR); Sang Ryeol LEE, Seoul (KR)

(73) Assignee: HANWHA CORPORATION, Seoul (KR)

(21) Appl. No.: 18/436,720

(22) Filed: Feb. 8, 2024

(30) Foreign Application Priority Data
Feb. 14, 2023 (KR) 10-2023-0019537

(51) Int. Cl. B28D 5/00; B28D 5/04

(52) U.S. Cl. CPC B28D 5/0082; B28D 5/0064; B28D 5/045

(57) ABSTRACT

A carrying apparatus configured to load and/or unload a brick includes: a main body; a transport support configured to move a brick to a brick cutting apparatus in which an insertion space is formed; a lift arm coupled to an upper end portion of the main body and configured to elevate or descend the transport support; and at least one wire connecting the transport support to the lift arm, where the transport support includes a guide rest connected to the at least one wire, and where the lift arm is configured to descend or elevate the transport support via the at least one wire and align the transport support with an alignment guide of the brick cutting apparatus such that the alignment guide corresponds with the guide rest in a vertical direction.

### CROSS-REFERENCE TO RELATED APPLICATION

This application is based on and claims priority from Korean Patent Application No. 10-2023-0019537, filed on Feb. 14, 2023, in the Korean Intellectual Property Office, the disclosure of which is incorporated herein in its entirety by reference.

### BACKGROUND

### 1. Field

This disclosure relates to a brick carrying apparatus configured for loading/unloading a brick, and a method capable of loading/unloading a silicon brick on/from a brick cutting apparatus during a process of manufacturing a wafer of a solar battery.

### 2. Description of the Related Art

Processes of manufacturing a wafer of a solar battery include a cutting process, in which a silicon brick is cut into thin wafers. Recently, a method of producing cut wafers by using a diamond wire saw (DWS) has been utilized as a method of cutting a silicon brick.

In order to cut thin wafers, a process of inserting a silicon brick into a brick cutting apparatus is necessary.

FIG. 1 shows a general process of inserting a silicon brick B into a brick cutting apparatus 20.

In general, in a process of inserting the silicon brick B into the brick cutting apparatus 20, a bar 10 formed at the upper end of the silicon brick B is inserted and pushed into a brick insert groove 22 of the brick cutting apparatus 20.

Here, a high-degree of precision is necessary because the brick B having a length of 900 mm or greater has to be inserted into the insert groove 22 of the brick cutting apparatus 20 having a tolerance of ±2 mm. When manual work is performed, an operator has a difficulty in adjusting fine warpage with the sense of his/her hands while pushing the brick into the groove of the brick cutting apparatus.

Also, in the case of using a general brick transport member, when the brick is fitted into the brick insert groove in order to insert the brick into the brick cutting apparatus, a restricted position adjustment of the brick in the up/down/left/right directions is only possible, and thus, it is difficult to precisely insert the brick B into the insert groove 22.

### SUMMARY

Provided is a carrying apparatus configured to load/unload a brick, and a method capable of precisely inserting a brick into a brick cutting apparatus.

However, the above technical features are exemplary, and the scope of the disclosure is not limited thereto.

Additional aspects will be set forth in part in the description which follows and, in part, will be apparent from the description, or may be learned by practice of the presented embodiments of the disclosure.

According to an aspect of an embodiment, a carrying apparatus configured to load and/or unload a brick may include: a main body; a transport support configured to move a brick to a brick cutting apparatus in which an insertion space is formed; a lift arm coupled to an upper end portion of the main body and configured to elevate or descend the transport support; and at least one wire connecting the transport support to the lift arm, where the transport support includes a guide rest connected to the at least one wire, and where the lift arm is configured to descend or elevate the transport support via the at least one wire and align the transport support with an alignment guide of the brick cutting apparatus such that the alignment guide corresponds with the guide rest in a vertical direction.

The alignment guide of the brick cutting apparatus may include a body coupled to an upper end portion of the insertion space, and at least one guide rail extending outward from a side of the body.

The guide rest may be formed in a plate shape, where the guide rest is configured to be seated on, and aligned with, an upper surface of the at least one guide rail.

The at least one guide rail may include at least one alignment groove recessed in an upper surface.

The at least one alignment groove may include an inclined surface.

The inclined surface may be 60 degrees or less.

The guide rest may include at least one ball caster is on a lower surface, where the at least one ball caster corresponds with the at least one alignment groove.

In a state in which the transport support descends, the at least one ball caster may be configured to align to a center of the at least one alignment groove along the inclined surface.

The at least one alignment groove may include a width that is greater than a diameter of the at least one ball caster.

The transport support may further include a brick holder on a lower end, where the brick holder is configured to grip an upper end portion of the brick and insert the brick into the brick cutting apparatus.

The brick cutting apparatus may further include a brick insertion track in the insertion space and configured to receive the brick transported by the carrying apparatus.

In a state in which the transport support is aligned with the alignment guide, the brick insertion track may correspond with the brick holder.

The carrying apparatus may further include a protrusion protruding downward from a lower side of the lift arm.

The protrusion may be configured to press an upper surface of the guide rest as to contact the transport support with at least one guide rail of the alignment guide.

The protrusion may include an elastic material.

The carrying apparatus may further include a transport base on a lower side of the main body and configured to control a position of the carrying apparatus.

The transport base may be configured to move the carrying apparatus to a position corresponding to the brick cutting apparatus.

According to an aspect of an embodiment, a method for loading and/or unloading a brick may include moving a transport support to a first position corresponding to a brick cutting apparatus in which an insertion space is formed; moving the transport support to a second position that is higher than an alignment guide that is on an outer side of the brick cutting apparatus; moving the transport support to a third position that corresponds to an upper portion of the alignment guide in a vertical direction; descending the transport support onto the alignment guide and moving the transport support to a fourth position aligned on the alignment guide; and in a state in which the transport support is at the fourth position, loading or unloading the brick, by a brick holder corresponding to a lower side of the transport support, respectively to or from the brick insertion space.

The alignment guide may include at least one guide rail extending outward from the brick cutting apparatus, where the at least one guide rail includes at least one alignment groove recessed in an upper surface, and where the moving of the transport support to the fourth position includes moving at least one ball caster on the transport support to a center of the at least one alignment groove.

The moving of the transport support to the fourth position may include pressing, by a protrusion, an upper portion of the transport support.

According to an aspect of an embodiment, a system configured for moving and cutting a brick may include a brick carrying apparatus; and a brick cutting apparatus, where the brick carrying apparatus includes a main body, a transport support configured to move a brick to the brick cutting apparatus in which an insertion space is formed, a lift arm coupled to an upper end portion of the main body and configured to elevate or descend the transport support, and at least one wire connecting the transport support to the lift arm, where the transport support includes a guide rest connected to the at least one wire, where the brick cutting apparatus includes an alignment guide on an outer side, the alignment guide corresponding to the guide rest, and where the lift arm is configured to descend or elevate the transport support via the at least one wire and align the transport support with the alignment guide of the brick cutting apparatus such that the alignment guide corresponds to the guide rest in a vertical direction.

The alignment guide of the brick cutting apparatus may include a body coupled to an upper end portion of the insertion space, and at least one guide rail extending outward from a side of the body, where the guide rest is configured to be seated on, and aligned with, an upper surface of the at least one guide rail.

The at least one guide rail may include at least one alignment groove recessed in an upper surface, the at least one alignment groove including an inclined surface, where the guide rest includes at least one ball caster on a lower surface, the at least one ball caster corresponding with the at least one alignment groove.

The brick cutting apparatus may further include a brick insertion track in the insertion space and configured to receive the brick moved by the carrying apparatus, where, in a state in which the transport support is aligned with the alignment guide, the brick insertion track corresponds with the transport support.

The carrying apparatus may further include a transport base on a lower side of the main body and configured to control a position of the carrying apparatus, where the transport base is configured to move the carrying apparatus to a position corresponding to the brick cutting apparatus.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a process of inserting a silicon brick into a brick cutting apparatus according to the related art;

FIG. 2 is a perspective view of a transport base, a brick loading/unloading apparatus, and a brick cutting apparatus according to an embodiment of the present disclosure;

FIG. 3 is an exploded perspective view of a brick carrying apparatus according to an embodiment of the present disclosure;

FIG. 4 is a diagram showing that a transport base transports a transport support of a brick carrying apparatus to a first position corresponding to a brick cutting apparatus, according to an embodiment of the present disclosure;

FIG. 5 is a diagram showing that a lift arm transports a transport support to a second position that is higher than an alignment guide, according to an embodiment of the present disclosure;

FIG. 6 is a diagram showing that a transport base transports a transport support of a brick carrying apparatus from an upper portion of an alignment guide to a third position corresponding to the alignment guide, according to an embodiment of the present disclosure;

FIG. 7 is a diagram showing that a lift arm descends a transport support and the transport support is seated and aligned on an alignment guide, according to an embodiment of the present disclosure;

FIG. 8 is a diagram showing that a transport support is seated and aligned on the alignment guide of FIG. 7, according to an embodiment of the present disclosure;

FIGS. 9A and 9B are diagrams shown from direction A of FIG. 7 according to an embodiment of the present disclosure; FIG. 9A is a diagram shown from an upper portion of an alignment guide when a transport support is descended based on an alignment guide according to an embodiment of the present disclosure; FIG. 9B is a diagram showing a state in which a guide rest is aligned and seated based on an alignment guide according to an embodiment of the present disclosure;

FIGS. 10A and 10B are cross-sectional views taken along line B-B′ of FIG. 9A according to an embodiment of the present disclosure; FIG. 10A is a diagram shown from the side portion of an alignment guide when a transport support is descended based on an alignment guide according to an embodiment of the present disclosure; FIG. 10B is a diagram showing a state in which a guide rest is aligned and seated based on an alignment guide according to an embodiment of the present disclosure;

FIG. 11 is a cross-sectional view taken along line C-C′ of FIG. 7 according to an embodiment of the present disclosure;

FIG. 12 is a diagram showing a brick inserted in an insertion space of a brick cutting apparatus after finishing the seating of a transport support , according to an embodiment of the present disclosure; and

FIG. 13 is a flowchart illustrating a brick loading/unloading method according to an embodiment of the present disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

As used herein, the term “and/or” includes any and all combinations of one or more of the associated listed items. Similarly, as used herein, the use of a slash “/” in between two terms, such as “loading/unloading,” includes any and all combinations of one or more of the associated terms. Expressions such as “at least one of,” when preceding a list of elements, modify the entire list of elements and do not modify the individual elements of the list.

While such terms as “first,” “second,” etc., may be used to describe various components, such components are not be limited to the above terms. The above terms are used only to distinguish one component from another.

An expression used in the singular encompasses the expression of the plural, unless it has a clearly different meaning in the context.

In the present specification, it is to be understood that the terms “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Sizes of components in the drawings may be exaggerated for convenience of explanation. In other words, since sizes and thicknesses of components in the drawings are arbitrarily illustrated for convenience of explanation, the following embodiments are not limited thereto.

When a certain embodiment is implemented differently, a specific process order may be performed differently from the described order. For example, two consecutively described processes may be performed substantially at the same time or performed in an order opposite to the described order.

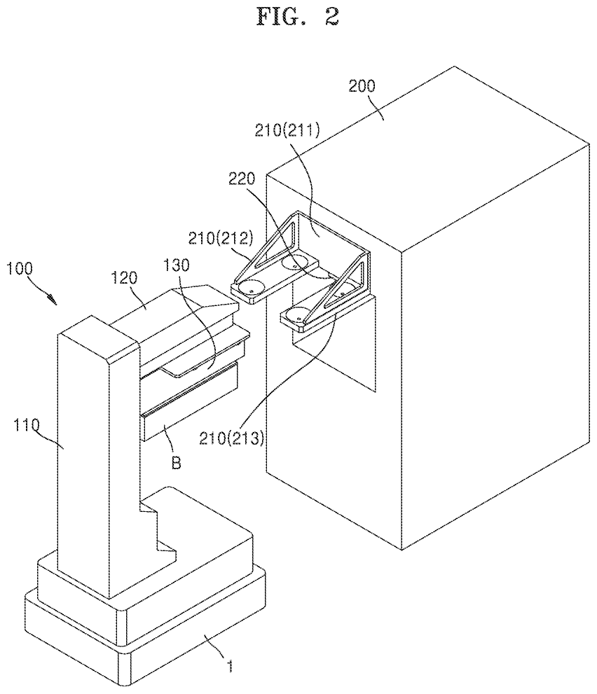

Hereinafter, a brick carrying apparatus according to an embodiment of the present disclosure is described below with reference to FIGS. 2, 3, and 7 to 11.

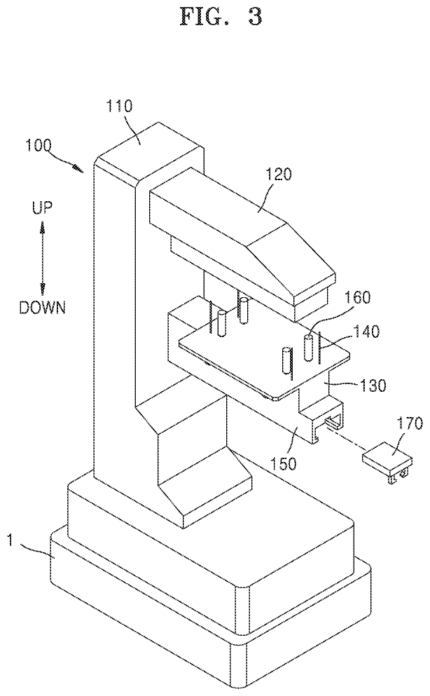

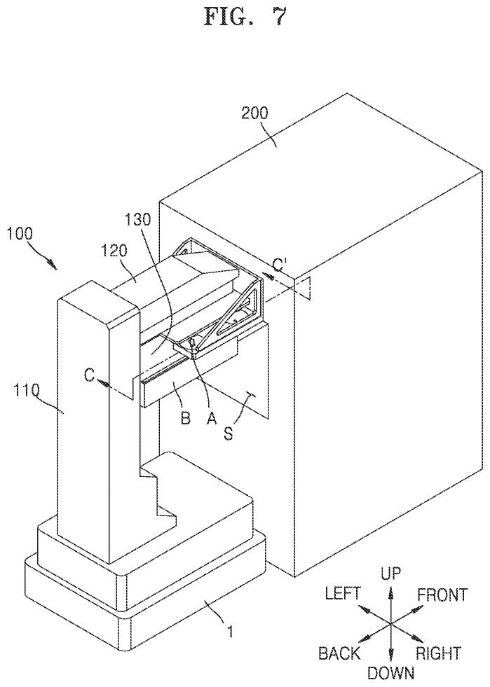

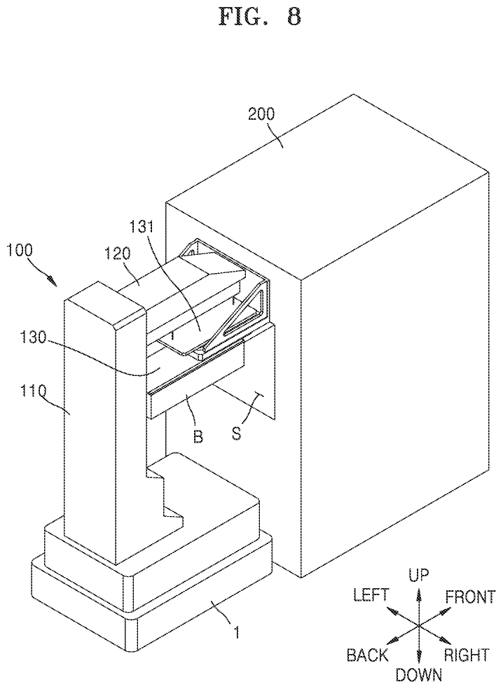

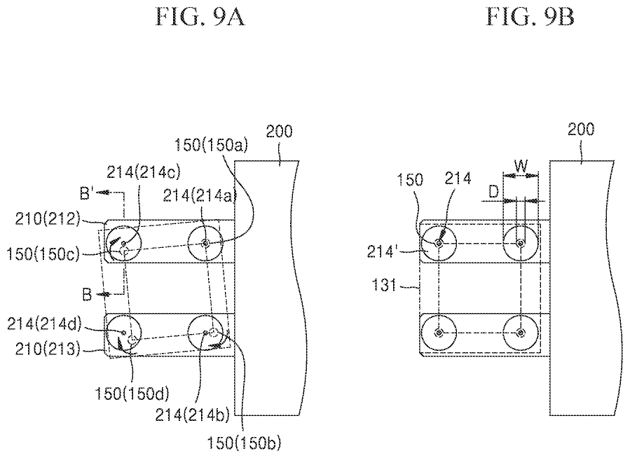

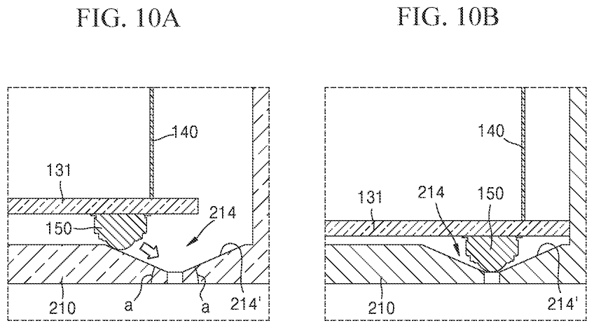

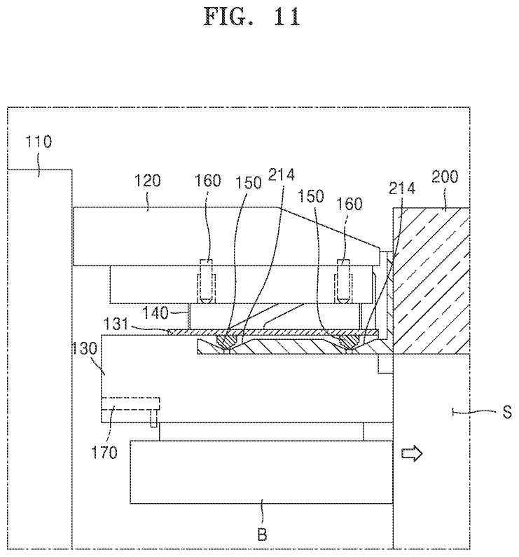

FIG. 2 is a perspective view of a transport base, a brick carrying apparatus, and a brick cutting apparatus according to an embodiment of the present disclosure. FIG. 3 is an exploded perspective view of a brick carrying apparatus according to an embodiment of the present disclosure. FIG. 7 is a diagram showing that a lift arm descends a transport support and the transport support is seated and aligned on an alignment guide, according to an embodiment of the present disclosure. FIG. 8 is a diagram showing that a transport support is seated and aligned on the alignment guide of FIG. 7. FIGS. 9A and 9B are diagrams shown from direction A of FIG. 7, and showing that a guide rest of a transport support is aligned when the transport support is aligned. FIG. 9A is a diagram shown from an upper portion of an alignment guide when a transport support is descended based on an alignment guide. FIG. 9B is a diagram showing a state in which a guide rest is aligned and seated based on an alignment guide, while a ball caster connected to the guide rest of a transport support is inserted in an alignment groove of the alignment guide and moves to the center of the alignment groove. FIGS. 10A and 10B are cross-sectional views taken along line B-B′ of FIG. 9A, and show that a guide rest of a transport support is aligned when the transport support is aligned. FIG. 10A is a diagram shown from the side portion of an alignment guide when a transport support is descended based on an alignment guide. FIG. 10B is a diagram showing a state in which a guide rest is aligned and seated based on an alignment guide, while a ball caster connected to the guide rest of a transport support is inserted in an alignment groove of the alignment guide and moves to the center of the alignment groove. FIG. 11 is a cross-sectional view taken along line C-C′ of FIG. 7, and shows a state in which a transport support is seated on an alignment guide.

Referring to the above drawings, a brick carrying apparatus 100 according to an embodiment of the present disclosure may include a transport base 1 transporting the brick carrying apparatus 100 to a brick cutting apparatus 200, and a transport support 130 which is attached to the brick carrying apparatus 100, is seated on an alignment guide 210 attached to the brick cutting apparatus 200, and transports a brick B into the brick cutting apparatus 200. Also, the brick carrying apparatus 100 may include a lift arm 120 for moving the transport support 130 in the up/down direction. Also, the lift arm 120 may be connected to the transport support 130 via wires 140, and in a state in which the lift arm 120 descends the transport support 130 by extending the wires 140, the transport support 130 may be seated on the alignment guide 210 while being aligned with 6-degrees of freedom.

The transport base 1 may be arranged under a main body 110 and may control the position of the brick carrying apparatus 100. The transport base 1 may transport the brick carrying apparatus 100 to a position corresponding to the brick cutting apparatus 200. Here, the transport base 1 may include an automated guided vehicle (AGV). The transport base 1 may include a controller module and a communication module, the controller module may include at least one processor such as a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, a machine learning accelerator, or the like, the transport base 1 may further include a power module, a sensor module, and a motor controller module, the motor controller module may be controlled by the controller module, and the motor may be driven by a power supply current supplied from the power module; alternatively, the motor may be operated by an internal combustion engine or similar power-generating unit. The transport base 1 may communicate with a main server to receive information about the brick cutting apparatus 200 to which a brick B needs to be loaded, from among a plurality of brick cutting apparatuses 200, and may transport the brick carrying apparatus 100 on which the brick B is loaded to the position where the corresponding brick cutting apparatus 200 is located. On the contrary, from among the plurality of brick cutting apparatuses 200, the transport base 1 may receive information about the brick cutting apparatus 200 from which the brick B needs to be unloaded, and may transport the brick carrying apparatus 100 on which the brick B is not loaded to the position where the corresponding brick cutting apparatus 200 is located.

According to an embodiment, the brick carrying apparatus 100 may load/unload the brick B onto/from the brick cutting apparatus 200 at the position corresponding to the brick cutting apparatus 200. The brick carrying apparatus 100 may include the main body 110, the lift arm 120 that is coupled to the upper end portion of the main body 110 and protrudes toward the brick cutting apparatus 200 in a state in which the brick carrying apparatus 100 is located at the position corresponding to the brick cutting apparatus 200, the transport support 130 connected to the lift arm 120 at the lower side portion of the lift arm 120, and the brick B loaded on the lower side of the transport support 130.

The lift arm 120 may move vertically based on the main body 110. Therefore, the lift arm 120 is moved in the up and down direction based on the main body 110 to adjust the position of the transport support 130 connected to the lift arm 120 when the brick carrying apparatus 100 is located at the position corresponding to the brick cutting apparatus 200. According to an embodiment, a guide rest 131 that is arranged on the upper end portion of the transport support 130 and is formed in a plate shape having a width greater than that of the transport support 130 may be seated on the upper surface of the alignment guide 210 that is installed on the outer side portion of the brick cutting apparatus 200 that will be described later. Thus, the lift arm 120 may move the transport support 130 upward so that the guide rest 131 formed on the transport support 130 may be located higher than the alignment guide 210. The transport base 1 may move the brick carrying apparatus 100 to a position where the guide rest 131 of the transport support 130 is aligned with the alignment guide 210 in the up and down directions while the transport support 130 is located higher than the alignment guide 210.

The lift arm 120 may be connected to the transport support 130 via the wires 140. The lift arm 120 may adjust the distance between the transport support 130 and the lift arm 120 by extending the wires 140. According to an embodiment, the lift arm 120 may move the transport support 130 downward by extending the wires 140, so that the guide rest 131 of the transport support 130 is seated on the upper surface of the alignment guide 210.

The wires 140 may be connected to the transport support 130. The wires 140 may be connected to the guide rest 131 of the transport support 130 so as to support the guide rest 131. For example, the wire 140 may be fixed on the upper surface of the guide rest 131 or the end portion of the wire 140 may be partially inserted and fixed in the guide rest 131. The wire 140 may be formed to pass through the upper and lower surfaces of the guide rest 131 of the transport support 130 and the end portion thereof may be partially fixed on the lower surface. According to an embodiment, the guide rest 131 may be formed in a square plate shape, and the wires 140 may be arranged on regions corresponding to four corners of the guide rest 131.

The wire 140 may include a material that is flexibly deformable. In a state in which the transport support 130 connected to the wires 140 is descended, the wires 140 may be bent when coming into contact with a certain component on the passage, e.g., the alignment guide 210, and guide a position of a ball caster 150 that is described later. Also, the wire 140 may include a metal material having rigid properties so as to support the transport support 130 supporting the brick B. The lift arm 120 and the transport support 130 may be connected to each other via various materials with different rigidities and having various shapes that may be bent between the two components (120 and 140).

According to an embodiment, the brick carrying apparatus 100 may include the ball caster 150. When the transport support 130 is descended and aligned on first and second guide rails 212 and 213, the ball caster 150 may be guided by alignment grooves 214 formed in the first and second guide rails 212 and 213. To this end, the ball caster 150 may be arranged on the transport support 130. For example, the ball caster 150 may be arranged on the lower surface of the guide rest 131. The ball caster 150 may be arranged on a region corresponding to the alignment groove 214. The ball caster 150 may be coupled to the guide rest 131 at the edge of the lower surface of the guide rest 131.

The alignment guide 210 coupled to the brick cutting apparatus 200 may include a body portion 211 that is coupled to the upper end portion of an insertion space S in the brick cutting apparatus 200, and the first and second guide rails 212 and 213 which extend from opposite side portions of the body portion 211 toward the outside of the brick cutting apparatus 200.

The alignment grooves 214 may be recessed in the upper surfaces of the first and second guide rails 212 and 213, and the ball caster 150 may be moved to the center of the alignment groove 214 due to the gravity. Therefore, the guide rest 131 connected to the ball caster 150 may be moved and aligned along the movement direction of the ball caster 150. Therefore, along with the alignment of the guide rest 131, the transport support 130 and the brick B loaded on the transport support may be minutely aligned so as to correspond to the position of the alignment guide 210. Due to the movement of the ball caster 150, the wires 140 may be misaligned in the up and down directions, and at this time, the wires 140 may be flexibly transformed and may maintain the transformed state in response to the alignment between the transport support 130 and the alignment guide 210.

According to an embodiment, the alignment groove 214 may include an inclined surface 214′. The ball caster 150 may be moved to the center of the alignment groove 214 along the inclined surface 214′. For example, referring to FIG. 10, an inclination angle (a) of the inclined surface 214′ with respect to the lower surfaces of the first and second guide rails 212 and 213 may be approximately 60-degrees or less. In a state in which the inclination angle (a) exceeds 60-degrees, the width of the upper surface of the alignment groove 214 may be reduced and it may be difficult to effectively guide the position of the ball caster 150. Also, in a state in which the inclination angle (a) exceeds 60-degrees, the size and depth of the alignment groove 214 for guiding the ball caster 150 may increase, and accordingly, reliability of the first and second guide rails 212 and 213 may degrade. The angle (a) of the inclined surface 214′ with respect to the lower surfaces of the first and second guide rails 212 and 213 may be approximately 45-degrees or less in consideration of the effective guidance of the ball caster 150 and the reliability of the first and second guide rails 212 and 213.

The alignment groove 214 may have a width w greater than a diameter D of the ball caster 150, so that the ball caster 150 may be easily inserted in the alignment groove 214. A recessed surface of the alignment groove 214 may be smooth. Accordingly, the ball caster 150 may be moved to the center of the alignment groove 214 along the smooth recessed surface of the alignment groove 214. According to an embodiment, ball casters 150a, 150b, 150c, and 150d may be respectively arranged on positions corresponding to four corners of the rectangular plate of the guide rest 131, and alignment grooves 214a, 214b, 214c, and 214d may be formed at the positions respectively corresponding to the ball casters 150a, 150b, 150c, and 150d.

The first and second guide rails 212 and 213 of the alignment guide 210 may be formed to be spaced apart from each other. The transport support 130 may be descended and located in the separation space. The guide rest 131 formed on the upper portion of the transport support 130 may have a width greater than that of the transport support 130, and thus, may be seated on the first and second guide rails 212 and 213 forming the separation space.

The ball casters 150a and 150b arranged at one side of the guide rest 131 may be inserted in the alignment grooves 214a an 214b of the first guide rail 212, and the ball casters 150b and 150d arranged at the other side of the guide rest 131 may be inserted in the alignment grooves 214b and 214d of the second guide rail 213.

In a state of inserting the brick B into the brick cutting apparatus 200, a precise positioning may be required in order to insert the brick B into the brick insertion track 220 of the brick cutting apparatus 200. Accordingly, during the process of aligning the transport support 130 on which the brick B is loaded at the position corresponding to the brick cutting apparatus 200, a precise positioning of the transport support 130 may be necessary.

Thus, according to an embodiment, the transport support 130 of the brick carrying apparatus 100 may be arranged at the position corresponding to the brick cutting apparatus 200, that is, in X-axis and Y-axis in the forward, backward, left, and right directions corresponding to the brick cutting apparatus 200 by the transport base 1; the arrangement of the transport support 130 in the Z-axis, that is, up and down directions, may be performed by the lift arm 120; and the guide rest 131 of the transport support 130 may be arranged on the alignment guide 210 of the brick cutting apparatus 200, with precise 6-degrees of freedom in X, Y, Z, Rx, Ry, and Rz axis directions through the insertion of the ball caster 150 into the alignment groove 214. Thus, the precise insertion position of the brick B may be determined based on the brick cutting apparatus 200, and accordingly, the brick B may be inserted into the brick cutting apparatus 200 while being precisely aligned.

The brick insertion track 220 may be arranged in the insertion space of the brick cutting apparatus 200 and may receive the brick B transferred by the brick carrying apparatus 100. The alignment guide 210 may be attached at the position corresponding to the brick insertion track 220. In a state of finishing the alignment of the transport support 130, the brick insertion track 220 may be arranged in the region corresponding to a holder 170, and may receive the brick B transferred through the holder 170.

Because the transport support 130 may be aligned based on the alignment guide 210, and the brick B loaded on the transport support 130 may be inserted into the brick insertion track 220 from the position corresponding to the brick insertion track 220, the alignment guide 210 may need to be installed on the outer surface portion of the brick cutting apparatus 200 at the position corresponding to the brick insertion track 220. According to an embodiment, the alignment guide 210 may be attached to the outer surface portion of the brick cutting apparatus 200 by a jig connected to the brick insertion track 220, and thus, the alignment guide 210 may be arranged on the brick cutting apparatus 200 to correspond to the position of the brick insertion track 220.

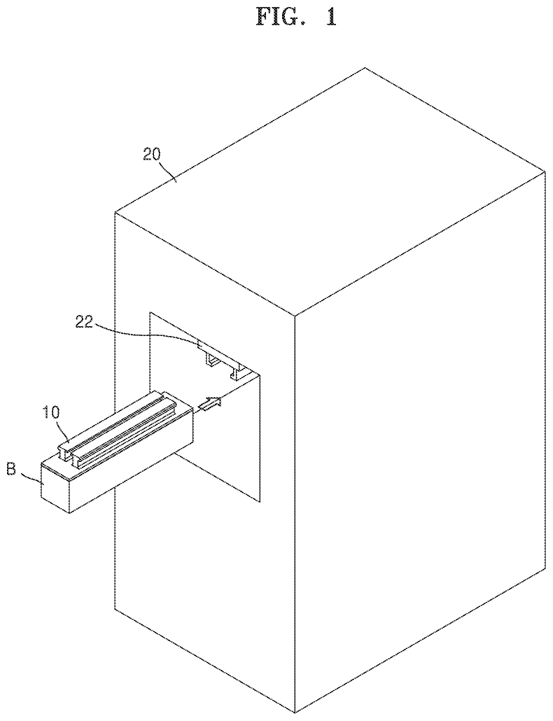

Referring to FIGS. 3 and 11, the transport support 130 according to an embodiment may include the holder 170 attached to the lower portion thereof. The holder 170 may slide on the lower portion of the transport support 130. The holder 170 may grip the brick B, and then, the holder 170 may be moved while gripping the upper end portion of the brick B, and insert the brick B into the brick cutting apparatus 200. For example, the holder 170 may load the brick B into the brick insertion track 220 arranged inside the brick cutting apparatus 200. To the contrary, the holder 170 may unload the brick from the brick insertion track 220 and bring the brick to the transport support 130. The holder 170 and the brick insertion track 220 may load and unload the brick in the back-and-forth directions while gripping the bar 10 at the upper end portion of the brick B, as shown in FIG. 1. The holder according to an embodiment may adopt various brick transport structures, e.g., a structure of vacuum sucking the brick, a structure of using a grip portion fastened to grip the brick, etc., rather than the gripping structure of the brick.

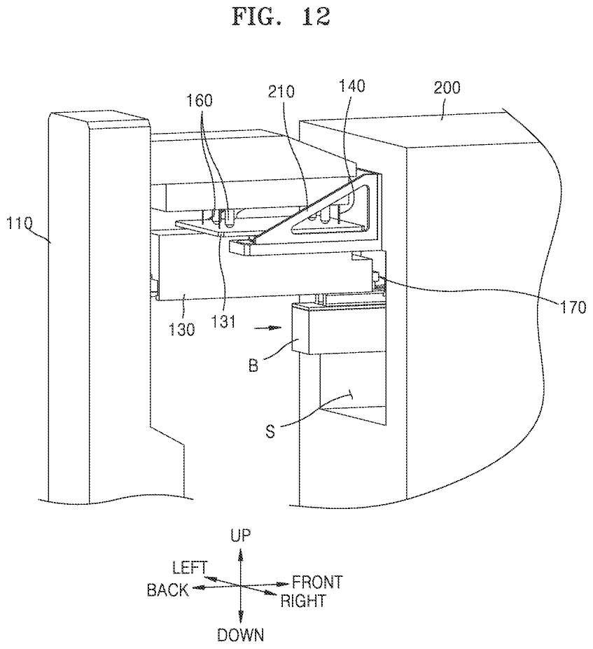

FIG. 12 shows a diagram of a brick being inserted in an insertion space of a brick cutting apparatus after finishing the seating of a transport support, according to an embodiment of the present disclosure.

Referring to FIG. 12, the lift arm 120 may further include a protrusion 160. The lift arm 120 may move the protrusion 160 to protrude downward from the lift arm 120.

The lower end portion of the protrusion 160 may press the upper side portion of the transport support 130 that is aligned and seated on the alignment guide 210, and may allow the transport support 130 to be in close contact with the first and second guide rails 212 and 213 of the alignment guide 210. Accordingly, the transport support 130 may be arranged at a set position on the alignment guide 210.

Also, the ball caster 150 may be moved to the center of the alignment groove 214 due to gravity after being inserted into the alignment groove 214, but the ball caster 150 may not be completely located at the center of the alignment groove 214 due to the frictional force and external force applied between the recessed surface of the alignment groove 214 and the ball caster 150. Therefore, according to an embodiment, the protrusion 160 may press the upper portion of the guide rest 131 of the transport support 130 so that the guide rest 131 may press the ball caster 150 in the direction toward the alignment groove 214, and thus, the ball caster 150 may be precisely located at the center of the alignment groove 214 along the inclined surface of the alignment groove 214. Thus, the precision in the alignment between the transport support 130 and the alignment guide 210 may be improved.

The protrusion 160 may be formed of, for example, a solid and rigid material, and thus, may improve the pressing force due to the rigidity. Alternatively, the protrusion 160 may be formed of an elastic material such as a spring, and thus, a damping effect of the impact applied to the guide rest 131 that is pressed may be obtained.

Hereinafter, the brick loading/unloading method according to an embodiment of the present disclosure is described below with reference to FIGS. 2 to 8, 12, and 13.

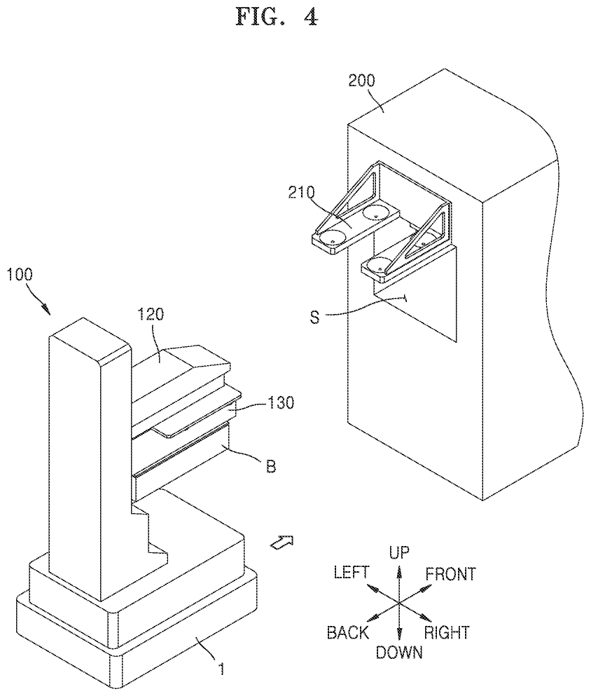

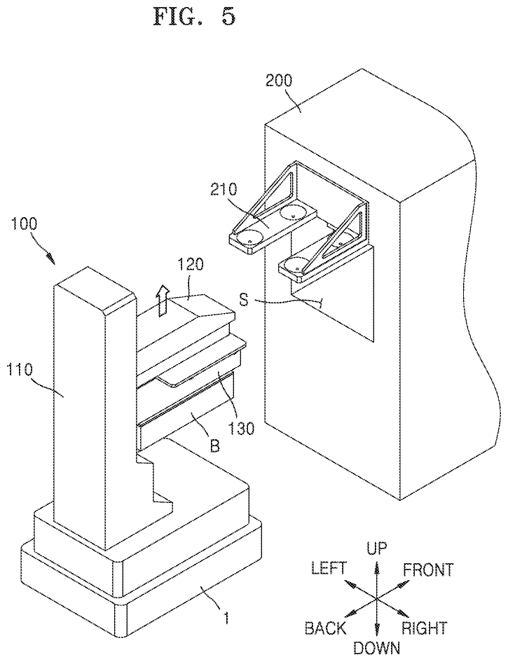

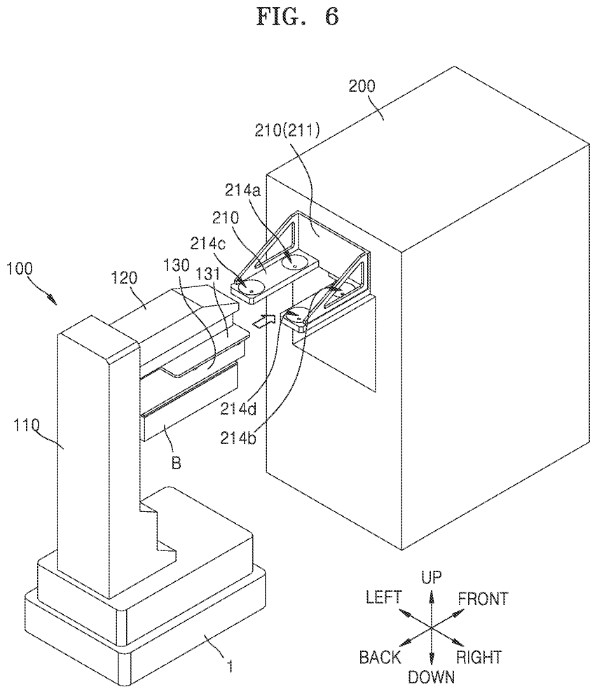

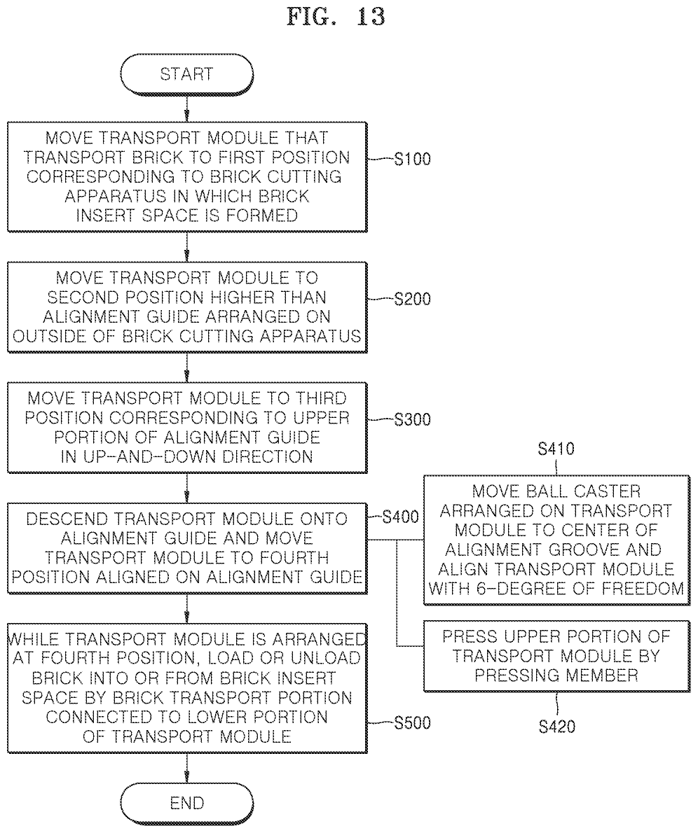

FIG. 2 is a perspective view of a transport base, a brick loading/unloading apparatus, and a brick cutting apparatus according to an embodiment of the present disclosure. FIG. 3 is an exploded perspective view of a brick carrying apparatus according to an embodiment of the present disclosure. FIG. 4 is a diagram showing that a transport base transports a transport support of a brick carrying apparatus to a first position corresponding to a brick cutting apparatus, according to an embodiment of the present disclosure. FIG. 5 is a diagram showing that a lift arm transports a transport support to a second position that is higher than an alignment guide, according to an embodiment of the present disclosure. FIG. 6 is a diagram showing that a transport base transports a transport support of a brick carrying apparatus from an upper portion of an alignment guide to a third position corresponding to the alignment guide, according to an embodiment of the present disclosure. FIG. 7 is a diagram showing that a lift arm descends a transport support and the transport support is seated and aligned on an alignment guide, according to an embodiment of the present disclosure. FIG. 8 is a diagram showing that a transport support is seated and aligned on the alignment guide of FIG. 7. FIG. 12 is a diagram showing that a brick is inserted in an insertion space of a brick cutting apparatus after finishing the seating of a transport support, according to an embodiment of the present disclosure. FIG. 13 is a flowchart illustrating a brick loading/unloading method according to an embodiment of the present disclosure.

The brick loading/unloading method according to an embodiment may include an operation (S100) in which the transport base 1 moves to the position corresponding to the brick cutting apparatus 200 with the brick carrying apparatus 100 loaded thereon, and the transport support 130 attached on the brick carrying apparatus 100 may be moved to a first position corresponding to the brick cutting apparatus 200 (see FIG. 4). That is, in the operation S100, the transport support 130 transporting the brick B may be moved to the first position corresponding to the brick cutting apparatus 200 in which the brick insertion space is formed.

The method may further include an operation (S200) in which the transport base 1 is stopped at the first position, and the brick carrying apparatus 100 moves the transport support 130 upward by using the lift arm 120, and the transport support 130 is moved to a second position that is higher than the alignment guide 210 (see FIG. 5). That is, in the operation S200, the transport support 130 may be moved to the second position that is higher than the alignment guide 210 that is arranged on the outer side of the brick cutting apparatus 200.

The method may further include an operation (S300) in which the transport base 1 moves the transport support 130 of the brick carrying apparatus 100, and the transport support 130 is moved from the upper portion of the alignment guide 210 to a third position corresponding to the alignment guide 210 (see FIG. 6). That is, in the operation S300, the transport support 130 may be moved to the third position corresponding to the upper portion of the alignment guide 210 in the up and down direction.

The method may further include an operation (S400) in which the lift arm 120 descends the transport support 130 via the wires 140 and the transport support 130 is seated on the alignment guide 210 while being aligned with 6-degrees of freedom to be moved to a fourth position (see FIGS. 7 and 8). That is, in the operation S400, the transport support 130 may be descended onto the alignment guide 210 and moved to the fourth position where the transport support 130 is aligned on the alignment guide 210.

The method may further include an operation (S500) in which, while the transport support 130 is arranged at the fourth position, the holder 170 connected to the lower portion of the transport support 130 transports the gripping brick B into the brick cutting apparatus 200 (see FIG. 12).

Thus, according to an embodiment, the processes, in which the transport support 130 of the brick carrying apparatus 100 is moved to the first position corresponding to the brick cutting apparatus 200 by the transport base 1, the transport support 130 is moved to the second position that is higher than the alignment guide 210 by the lift arm 120, the transport support 130 is moved to the third position corresponding to the alignment guide 210 by the transport base 1, and the transport support 130 that is descended by the lift arm 120 is moved to the fourth position, where the alignment with 6-degrees of freedom is performed, through the process of inserting and aligning the ball caster 150 in the alignment groove 214, may be sequentially performed. That is, according to an embodiment, even if the transport support 130 is awry because the transport base 1 is not aligned in the left, right, forward, and backward directions as shown in FIG. 9A, the position of the transport support 130 may be precisely adjusted based on the brick cutting apparatus 200, and thus, the brick B located on the transport support 130 may be transported into the brick cutting apparatus 200 without an error, and the precision in the transportation may be greatly improved.

Also, according to an embodiment, the process in which the transport support is moved to the fourth position may include an operation (S410), in which the ball caster 150 attached to the transport support 130 is inserted in the alignment groove 214 that is recessed in the alignment guide 210, and the transport support 130 is aligned with 6-degrees of freedom while the ball caster 150 is moved to the center of the alignment groove 214.

Also, according to the embodiment, the lift arm 120 may include the protrusion 160, and after the process in which the transport support 130 is moved to the fourth position, an operation (S420) in which the protrusion 160 presses the transport support 130 so that the transport support 130 is coupled in close contact with the alignment guide 210 may be performed.

Throughout the specification, in particular, in claims, “the” or other similar referring expressions may refer to both a singular form and a plural form. Unless otherwise defined, the ranges defined herein is intended to include values within the range as individually applied and may be considered to be the same as individual values constituting the range in the detailed description. Also, operations constituting methods may be performed in appropriate order unless explicitly described in terms of order or described to the contrary. Exemplary embodiments are not necessarily limited to the order of operations given in the description. The examples or exemplary terms (for example, etc.) used herein are to merely describe exemplary embodiments in detail are not intended to limit the embodiments unless defined by the following claims. Also, those of ordinary skill in the art will readily appreciate that many alternations, combinations and modifications, may be made according to design conditions and factors within the scope of the appended claims and their equivalents.

The brick carrying apparatus according to one or more embodiments may adjust the warpage in every direction (X, Y, Z, Rx, Ry, and Rz) with 6-degrees of freedom through the structure in which the transport support is aligned and seated on the alignment guide, and may adjust the warpage in every direction with the 6-degrees of freedom only with the structure of seating the transport support.

The brick carrying apparatus according to one or more embodiments may reduce modification of an existing brick cutting apparatus for brick insertion, because the alignment guide may be only attached to the outer surface of the brick cutting apparatus.

The brick carrying apparatus according to one or more embodiments may not need to additionally install an apparatus for aligning and inserting the brick, e.g., a gantry robot, etc., for every brick cutting apparatus, and the transport base may move around to load/unload the brick to/from the brick cutting apparatuses. Thus, convenience in the processes may be achieved through the automation of the brick insertion.

The effects of the present disclosure are not limited to the aforementioned effects, and other effects of the present disclosure may be understood by the following description and will become apparent from the embodiments of the present disclosure.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A carrying apparatus configured to load and/or unload a brick comprising:
a main body;
a transport support configured to move a brick to a brick cutting apparatus in which an insertion space is formed;
a lift arm coupled to an upper end portion of the main body and configured to elevate or descend the transport support; and
at least one wire connecting the transport support to the lift arm,
wherein the transport support comprises a guide rest connected to the at least one wire, and wherein the lift arm is configured to descend or elevate the transport support via the at least one wire and align the transport support with an alignment guide of the brick cutting apparatus such that the alignment guide corresponds with the guide rest in a vertical direction.

2. The carrying apparatus of claim 1, wherein the alignment guide of the brick cutting apparatus comprises:
a body coupled to an upper end portion of the insertion space; and
at least one guide rail extending outward from a side of the body.

3. The carrying apparatus of claim 2, wherein the guide rest is formed in a plate shape, and
wherein the guide rest is configured to be seated on, and aligned with, an upper surface of the at least one guide rail.

4. The carrying apparatus of claim 2, wherein the at least one guide rail comprises at least one alignment groove recessed in an upper surface.

5. The carrying apparatus of claim 4, wherein the at least one alignment groove comprises an inclined surface.

6. The carrying apparatus of claim 5, wherein the inclined surface is 60 degrees or less.

7. The carrying apparatus of claim 5, wherein the guide rest comprises at least one ball caster is on a lower surface, and
wherein the at least one ball caster corresponds with the at least one alignment groove.

8. The carrying apparatus of claim 7, wherein, in a state in which the transport support descends, the at least one ball caster is configured to align to a center of the at least one alignment groove along the inclined surface.

9. The carrying apparatus of claim 7, wherein the at least one alignment groove comprises a width that is greater than a diameter of the at least one ball caster.

10. The carrying apparatus of claim 1, wherein the transport support further comprises a brick holder on a lower end, and
wherein the brick holder is configured to grip an upper end portion of the brick and insert the brick into the brick cutting apparatus.

11. The carrying apparatus of claim 10, wherein the brick cutting apparatus further comprises a brick insertion track in the insertion space and configured to receive the brick transported by the carrying apparatus.

12. The carrying apparatus of claim 11, wherein, in a state in which the transport support is aligned with the alignment guide, the brick insertion track corresponds with the brick holder.

13. The carrying apparatus of claim 1, further comprising a protrusion protruding downward from a lower side of the lift arm.

14. The carrying apparatus of claim 13, wherein the protrusion is configured to press an upper surface of the guide rest as to contact the transport support with at least one guide rail of the alignment guide.

15. The carrying apparatus of claim 13, wherein the protrusion comprises an elastic material.

16. The carrying apparatus of claim 1, further comprising a transport base on a lower side of the main body and configured to control a position of the carrying apparatus.

17. The carrying apparatus of claim 16, wherein the transport base is configured to move the carrying apparatus to a position corresponding to the brick cutting apparatus.

18. A method for loading and/or unloading a brick comprising:
moving a transport support to a first position corresponding to a brick cutting apparatus in which an insertion space is formed;
moving the transport support to a second position that is higher than an alignment guide that is on an outer side of the brick cutting apparatus;
moving the transport support to a third position that corresponds to an upper portion of the alignment guide in a vertical direction;
descending the transport support onto the alignment guide and moving the transport support to a fourth position aligned on the alignment guide; and
in a state in which the transport support is arranged at the fourth position, loading or unloading the brick, by a brick holder corresponding to a lower side of the transport support, respectively to or from the brick insertion space.

19. The method of claim 18, wherein the alignment guide comprises at least one guide rail extending outward from the brick cutting apparatus,
wherein the at least one guide rail comprises at least one alignment groove recessed in an upper surface, and
wherein the moving of the transport support to the fourth position comprises moving at least one ball caster arranged on the transport support to a center of the at least one alignment groove.

20. The method of claim 18, wherein the moving of the transport support to the fourth position comprises pressing, by a protrusion, an upper portion of the transport support.

21. A system configured for moving and cutting a brick comprising:
a brick carrying apparatus; and
a brick cutting apparatus,
wherein the brick carrying apparatus comprises:
a main body,
a transport support configured to move a brick to the brick cutting apparatus in which an insertion space is formed,
a lift arm coupled to an upper end portion of the main body and configured to elevate or descend the transport support, and
at least one wire connecting the transport support to the lift arm,
wherein the transport support comprises a guide rest connected to the at least one wire,
wherein the brick cutting apparatus comprises an alignment guide on an outer side, the alignment guide corresponding to the guide rest, and
wherein the lift arm is configured to descend or elevate the transport support via the at least one wire and align the transport support with the alignment guide of the brick cutting apparatus such that the alignment guide corresponds to the guide rest in a vertical direction.

22. The system of claim 21, wherein the alignment guide of the brick cutting apparatus comprises a body coupled to an upper end portion of the insertion space, and at least one guide rail extending outward from a side of the body, and
wherein the guide rest is configured to be seated on, and aligned with, an upper surface of the at least one guide rail.

23. The system of claim 22, wherein the at least one guide rail comprises at least one alignment groove recessed in an upper surface, the at least one alignment groove comprising an inclined surface,
wherein the guide rest comprises at least one ball caster on a lower surface, the at least one ball caster corresponding with the at least one alignment groove.

24. The system of claim 23, wherein the brick cutting apparatus further comprises a brick insertion track in the insertion space and configured to receive the brick moved by the carrying apparatus, and
wherein, in a state in which the transport support is aligned with the alignment guide, the brick insertion track corresponds with the transport support.

25. The system of claim 21, wherein the carrying apparatus further comprises a transport base on a lower side of the main body and configured to control a position of the carrying apparatus, and
wherein the transport base is configured to move the carrying apparatus to a position corresponding to the brick cutting apparatus.
